(19) United States
(12) Patent Application Publication
(10) Pub. No.: US 2005/0068873 A1
(43) Pub. Date: Mar. 31, 2005

(54) Optical disc identification apparatus and method

(76) Inventor: Dong-woo Chung, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/933,361

(22) Filed: Sep. 3, 2004

(30) Foreign Application Priority Data
Sep. 30, 2003 (KR) 2003-67847

(51) Int. Cl. G11B 7/00

(52) U.S. Cl. 369/53.23; 369/44.25

(57) ABSTRACT

Disclosed is optical disc identification apparatus and method. The present invention can identify the kind of optical discs using the different peak-to-peak values of a focus error signal that is produced depending upon the kind of optical disc loaded into the disc drive. That is, the present invention can identify the kind of loaded optical disc using the number and magnitude of peak-to-peak values of a focus error signal detected during a time period when a light source for CDs is turned on and the magnitude of a peak-to-peak value of a focus error signal detected during a time period for which a light source for DVDs is turned on, the number of peak values, and an interval between peak values. Accordingly, the present invention can reduce the time it takes to identify the kind of loaded optical disc, and increase the identification accuracy of the kind of optical disc.

### CROSS-REFERENCE TO RELATED APPLICATION

This application claims the benefit under 35 U.S.C. § 119(a) of Korean Patent Application No. 2003-67847, filed on Sep. 30, 2003, in the Korean Intellectual Property Office, the disclosure of which is incorporated herein by reference in its entirety.

### BACKGROUND OF THE INVENTION

1. Field of the Invention

The present invention relates to an optical disc identification apparatus and a method thereof. More particularly, the present invention relates to an optical disc identification apparatus and a method for identifying the kind of optical disc loaded in a disc drive using the peak-to-peak value of the focus error signal.

2. Description of the Related Art

Various kinds of optical discs are widely used as information storage media, so optical disc recording and or reproducing devices are now designed to reproduce or record information from or onto at least two kinds of optical discs.

Accordingly, when an optical disc is loaded into a disc drive, the optical disc recording and or reproducing apparatus must identify the kind of optical disc loaded into the disc drive. Until now it has been enough for a conventional CD and DVD reproducing devices to only identify those two kinds of optical discs.

However, in recent years, because optical discs are used more widely as a recording medium, there are available many diverse kinds of optical discs. Since there are many common optical characteristics among the different kinds of optical discs, the reproducing device's optical disc identifying accuracy is reduced when only one reference is used in identifying the kind of optical disc loaded in the disc drive. Further, in the case of executing an identification routine step by step based on a variety of references in order to increase accuracy, the apparatus wastes time stepping through every single reference.

Accordingly, with the many different kinds of optical discs, a method is required for optical disc recording and reproducing devices to more rapidly and precisely identify the kind of optical disc.

### SUMMARY OF THE INVENTION

Accordingly, it is an aspect of the present invention to provide an optical disc identification method and apparatus capable of identifying the kind of optical disc preferably based on a peak-to-peak value of a focus error (FE) signal that is different according to the kind of optical disc loaded in the drive.

In order to identify the kind of optical disc in use, the optical disc identification apparatus according to an embodiment of the present invention turns on a light source for CDs during the rising period of the focus actuator, and turns on a light source for DVDs during the falling period of the focus actuator. The present invention generates a focus error signal based on laser beams reflected from the loaded optical disc when the light sources for CDs and DVDs are turned on, respectively.

Further, the present invention decides whether the loaded optical disc belongs to a CD type or a DVD type based on the magnitudes of the peak values of the focus error signal detected during the time period when the light source for CDs is turned on and during the time period when the light source for DVDs is turned on. If a general CD is loaded, the peak value of the focus error signal detected during the time period when the light source for CDs is turned on appears relatively larger than a peak value of a focus error signal detected during the time period when the light source for DVDs is turned on. If a DVD is loaded, a peak value of the focus error signal detected during the time period when the light source for DVDs is turned on appears larger than a peak value of a focus error signal detected during the time period when the light source for CDs is turned on. Accordingly, the optical disc identification apparatus can decide whether the loaded optical disc is a CD type or a DVD type optical disc based on the magnitude of a peak value of the focus error signal detected during the time period when the light sources for a CD and DVD are turned on, respectively.

Additionally, if a loaded optical disc is determined to be a CD type or a DVD type, the optical disc identification apparatus supplements the classification of the kind of optical disc, which are first classified based on information on the number of peaks (the number of occurrences of S-curves) and an interval between peak values of the focus error signal detected during the rising and falling periods of a focus actuator.

If it is decided that an optical disc loaded in the optical disc drive belongs to a CD type, the optical disc identification apparatus compares a predetermined threshold value with a peak value of a focus error signal detected during the time period when the light source for CDs is turned on, and decides whether the loaded CD is a normal CD or a CD-RW.

In the meantime, if it is decided that the loaded optical disc belongs to a DVD type, the optical disc identification apparatus compares the predetermined threshold value with a peak value of an FE signal detected during the time period when the light source for DVDs is turned on, and decides whether the loaded DVD is a normal DVD or a DVD-RW.

Further, if it is decided that the loaded DVD is a normal DVD, the optical disc identification apparatus checks the number of peaks of the FE signal detected during the time period for which the light source for DVDs is turned on, and decides whether the loaded DVD is a single-layer disc or a dual-layer disc. At this time, if it is decided that the loaded DVD is a dual-layer disc, the optical disc identification apparatus decides whether the dual-layer disc is a dual-layer DVD or a hybrid disc based on the interval between the peaks.

### BRIEF DESCRIPTION OF THE DRAWINGS

The present invention will be described in detail with reference to the following drawings in which like reference numerals refer to like elements, and wherein:

FIG. 1 is a schematic block diagram for showing an exemplary optical disc identification apparatus according to an embodiment of the present invention;

FIG. 2A is a view for showing an exemplary waveform with respect to an FE signal detected when a CD is loaded in the exemplary optical disc identification apparatus of FIG. 1 according to an embodiment of the present invention;

FIG. 2B is a view for showing an exemplary waveform with respect to an FE signal detected when a single layer DVD (DVD-S) is loaded in an exemplary optical disc identification apparatus of FIG. 1 according to an embodiment of the present invention;

FIG. 2C is a view showing an exemplary waveform with respect to an FE signal detected when a dual layer DVD (DVD-D) is loaded in the exemplary optical disc identification apparatus of FIG. 1 according to an embodiment of the present invention; and

FIG. 3 and FIG. 4 are flow charts explaining an exemplary optical disc identification method for the optical disc identification apparatus of FIG. 1 according to an embodiment of the present invention.

### DETAILED DESCRIPTION OF THE PREFERRED EMBODIMENTS

Hereinafter, the present invention is described in detail with reference to the accompanying drawings.

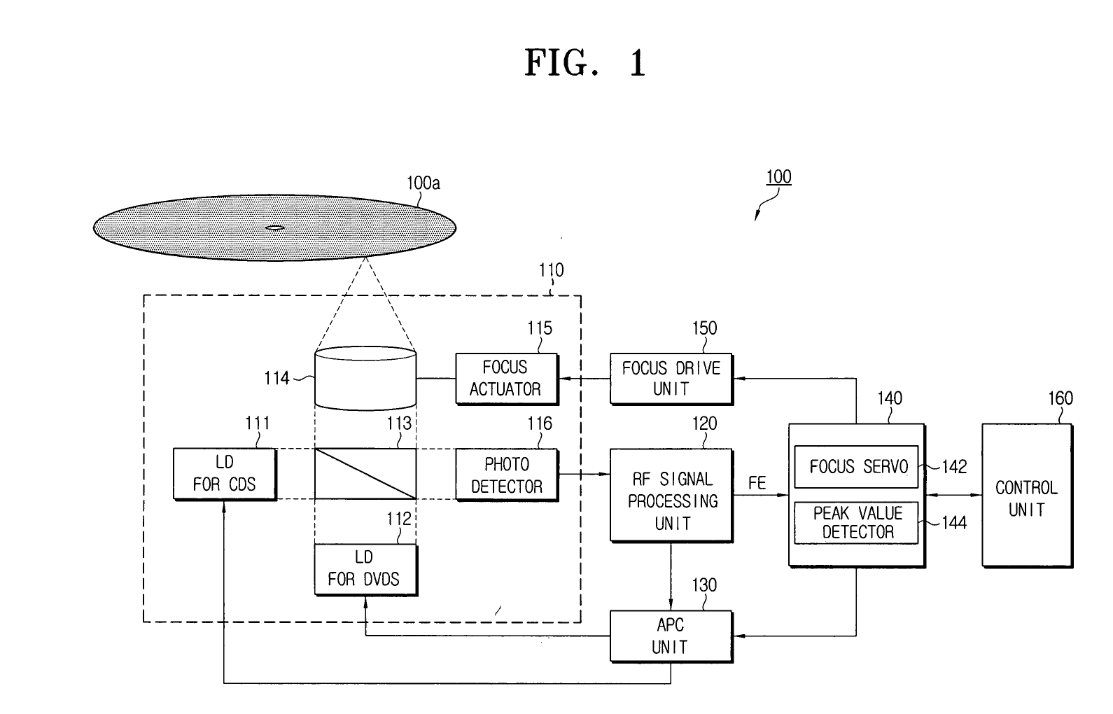

FIG. 1 is a schematic block diagram for showing an exemplary optical disc identification apparatus according to an embodiment of the present invention. Referring to FIG. 1, an optical disc identification apparatus 100 according to an embodiment of the present invention has an optical disc 100a, a pickup unit 110, an RF signal processing unit 120, an Automatic Power Control (APC) unit 130, a servo unit 140, a focus drive unit 150, and a control unit 160.

The optical disc identification apparatus 100 according to the present invention is provided in an optical disc drive unit capable of recording data on and or reproducing data from two or more kinds of optical discs.

The pickup unit 110 is provided with a laser diode 111 for CDs, which emits infrared light having a wavelength of about 780 nm, and a laser diode 112 for DVDs, which emits visible light having a wavelength of about 650 nm. The pickup unit 110 also has a beam splitter 113 for reflecting and passing in a predetermined ratio laser beams emitted from the laser diode 111 for CDs or the laser diode 112 for DVDs. The objective lens 114 focuses laser beams incident from the beam splitter 113 onto a recording layer of the optical disc 100a and a photo detector 116 detects the amount of laser light reflected from the optical disc 100a. A focus actuator 115 drives the objective lens 114 upwards and downwards to precisely focus the laser beams incident from the optical disc 100a onto the photo detector 116.

In the meantime, the present embodiment shows the laser diode 111 for CDs and the laser diode 112 for DVDs separated from each other for the sake of explanation, but the present invention should not be limited to only this embodiment. Of course, the present invention can be implemented with the laser diode 111 for CDs and the laser diode 112 for DVDs formed in one case.

The RF signal processing unit 120 generates a focus error (FE) signal for a focus servo based on the amount of light detected by the photo detector 116. The FE signal generated from the RF signal processing unit 120 is provided to the servo unit 140. A detailed description on an FE signal generation method will be omitted because such methods are well known to those of ordinary skill in the art.

The APC unit 130 is driven according to the controls of the servo unit 140, and detects the amount of light emitted from each of the laser diodes 111, 112 to automatically control the amount of light emitted from the laser diode 111 for CDs and the laser diode 112 for DVDs.

The servo unit 140 is provided with a focus servo 142 and a peak value detector 144. The focus servo 142 provides a focus drive (FOD) signal to the focus drive unit 150 to drive the focus actuator 115 based on an FE signal output from the RF signal processing unit 120. That is, the focus servo 142 provides the FOD signal to the focus drive unit 150 to move up and down the focus actuator 115 which moves the objective lens 114 upwards and downwards tto focus on the signal-recorded surface of the optical disc 100a.

The peak value detector 144 detects a peak-to-peak value of the FE signal output from the RF signal processing unit 120. That is, the peak value detector 144 detects a peak value of an S-curve occurring in the FE signal when the signal-recorded surface of the optical disc 100a is brought into a focus by the objective lens 114. The peak value detector 144 detects a first peak value on a first S-curve occurring in the FE signal detected during the rising period of the FOD signal for moving the focus actuator 115 upwards. The peak value detector 144 detects a second peak value on a second S-curve occurring in the FE signal detected during the falling period of the FOD signal for moving the focus actuator 115 downwards. The first and second detected peak values are sent to the control unit 160 which will be described later.

The focus drive unit 150 amplifies the FOD signal provided from the focus servo 142 up to a power level suitable for driving the focus actuator 115, and supplies the amplified FOD signal to the focus actuator 115 thereby driving the focus actuator 115.

The control unit 160 controls the overall operation of the optical disc identification apparatus 100 according to various control programs stored in a memory unit (not shown). If the optical disc 100a is loaded in an optical disc drive, the control unit 160 performs an identification operation to identify the kind of loaded optical disc 100a.

In order to identify the kind of loaded optical disc 100a, the control unit 160 controls the focus servo 142 to provide the FOD signal to the focus actuator 115 so the focus actuator 115 moves upwards and/or downwards with respect to the optical disc 100a. Further, the control unit 160 controls the APC unit 130 to turn on the laser diode 111 for CDs during the FOD signal rising period, to move the focus actuator 115 upwards. Control unit 160 also turns on the laser diode 112 for DVDs during the FOD signal falling period, to move the focus actuator 115 downwards. However, the control unit 160 is not limited to only the above sequence of operations, but can be implemented to turn on the laser diode 112 for DVDs during the FOD signal rising period and turn on the laser diode 111 for CDs during the FOD signal falling period.

If the servo unit 140 calculates the first and second peak values as to the first and second S-curves occurring in the FE signal during the rising and falling periods of the FOD signal for moving the focus actuator 115 upwards and downwards, the control unit 160 identifies the kind of loaded optical disc 100a based on the number and magnitude of the first and second peak values. In more detail, the control unit 160 preferably detects the number of occurrences of the first and second S-curves and the interval size between the first and second S-curves based on the number and magnitude of the first and second peak values input from the servo unit 140. The control unit 160 counts the number of all peak values input from the servo unit 140 during the rising and falling periods of the focus actuator 115 so that it can detect the number of occurrences of the first and second S-curves and the interval size between the respective S-curves. The control unit 160 identifies the kind of loaded optical disc 100a based on the number and magnitude of the first and second peak values input from the servo unit 140 and the number of occurrences of S-curves and the interval size between the respective S-curves which is detected based on the number and magnitude of the peak values.

The control unit 160 preferably identifies the kind of loaded optical disc 100a in the exemplary manner shown in Table 1. The following Table 1 shows the magnitudes of the peak values with respect to the FE signal detected by the servo unit 140.

TABLE 1

| | Laser diode turned on for | Laser diode turned on for |
|---|---|---|
| Kinds | CDs | DVDs |
| of optical discs | First peak value | Second peak value |
| DVD-S (Single | Low | High |
| layer) | | |
| DVD-D (Dual | Low | High |
| layer) | | |
| DVD-RW | Low | Middle |
| CD | High | Low |
| CD-RW | Middle | Low |

In order to identify the kind of an optical disc, the control unit 160 compares the first peak value and the second peak value. As a result of the comparison, if the first peak value detected during a time period for which the laser diode 111 for CDs is turned on is larger than the second peak value which is detected during a time period for which the laser diode 112 for DVDs is turned on and exceeds a first predetermined level, the control unit 160 decides the loaded optical disc 100a is a compact disc (CD). On the contrary, if the second peak value detected during a time period for which the laser diode 112 for DVDs is turned on is less than the first peak value, which is detected during a time period for which the laser diode 111 for CDs is turned on, and within a second predetermined level, the control unit 160 decides that the loaded optical disc 100a is a digital versatile disc (DVD).

After the control unit 160 identifies the kind of loaded optical disc 100a based on a magnitude difference of the first and second peak values as described above, the control unit 160 further classifies the kinds of discs more based on the number of occurrences of the first and second S-curves and the intervals between the respective curves based on the first and second peak values. For example, if the loaded optical disc 100a is determined to be a CD, the control unit 160 compares the first peak value with a predetermined first threshold value in order to decide whether the loaded CD is a normal CD or a rewritable RW disc (CD-RW). If the first peak value is larger than the first threshold value as a result of the comparison, the control unit 160 decides the loaded optical disc 100a is a normal disc (CD). If the first peak value is smaller than the first threshold value, the control unit 160 decides the loaded optical disc 100a is an RW disc (CD-RW), which is because the peak value for a normal disc is usually greater than a certain level than the peak value for the RW disc. At this time, the peak value for the CD-RW has a value smaller than the first threshold value, but the peak value for the CD-RW has to be a value within a reference peak value range for the CD-RW.

In the meantime, if the loaded optical disc 100a is determined to be a DVD, the control unit 160 compares the second peak value with a predetermined second threshold value in order to decide whether a loaded DVD is a rewritable (RW) disc (DVD-RW) or a normal disc (DVD-S or DVD-D). If it is decided that the second peak value is larger than the second threshold value as a result of the comparison, the control unit 160 decides the loaded DVD is a normal disc (DVD-S or DVD-D), and, if it is decided that the second peak value is smaller than the second threshold value, the control unit decides the loaded DVD is a RW disc (DVD-RW). Further, if it is decided that the loaded DVD is a normal DVD, the control unit 160 decides whether the loaded DVD is a single-layer disc (DVD-S) or a dual-layer disc (DVD-D) based on the number of occurrences of the second S-curves detected during a time period for which the laser diode for DVDs is turned on. That is, the control unit 160 decides the loaded DVD is a single-layer disc (DVD-S) if the second S-curve occurs once during the time period for which the laser diode 112 for DVDs is turned on.

In the meantime, if it is decided that the second S-curve occurs twice during the time period for which the laser diode 112 for DVDs is turned on, the control unit 160 decides the loaded DVD is a dual-layer disc. Furthermore, the control unit 160 decides whether the dual-layer disc is a DVD-D or a hybrid disc (HD) using the interval size between occurrences of second S-curves. That is, the control unit 160 decides the dual-layer disc is a hybrid disc if the detected interval between occurrences of second S-curves is more than a predetermined reference interval size, for example, about 0.6 mm, and a DVD-D if the detected interval is less than the predetermined reference interval. A hybrid disc is a disc capable of recording or reproducing both DVD and CD data, and the hybrid disc may be a Super Audio Compact disc (SACD), for example, which has a CD layer and a high density layer together. The dual layer hybrid disc has two layers formed at about 0.6 mm and about 1.2 mm, respectively, whereas all the DVD-D layers are formed at about 0.6 mm. Accordingly, the control unit 160 decides the loaded DVD is a hybrid disc if the interval between the second S-curve has a value approximate to 0.6 mm.

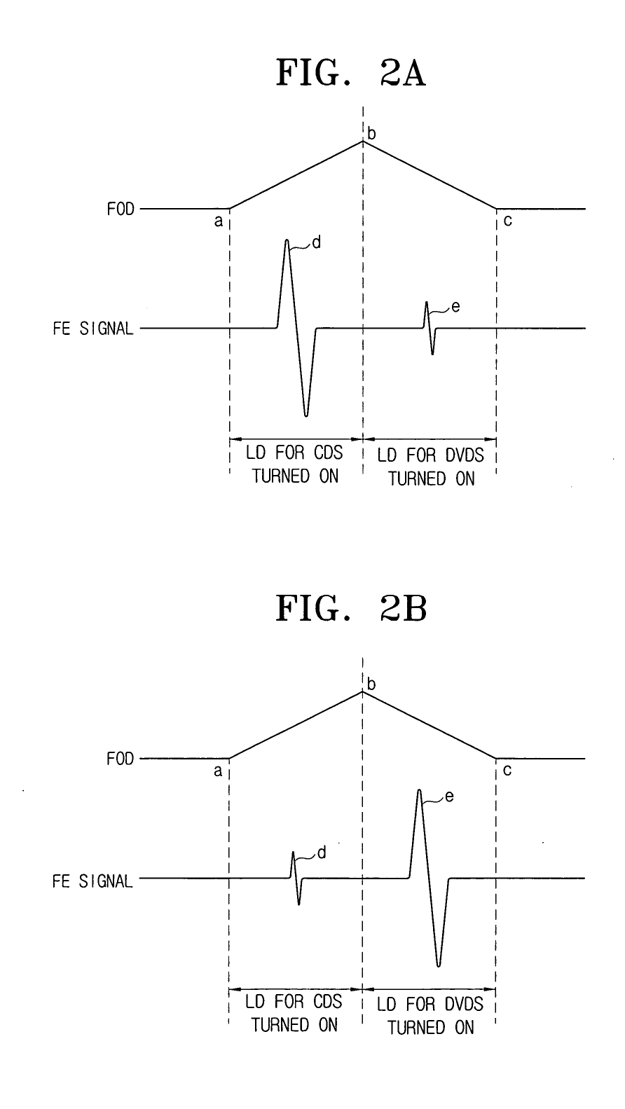

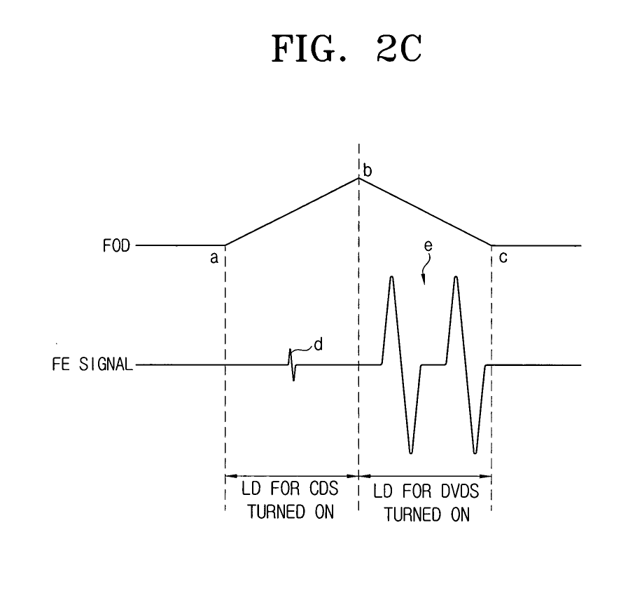

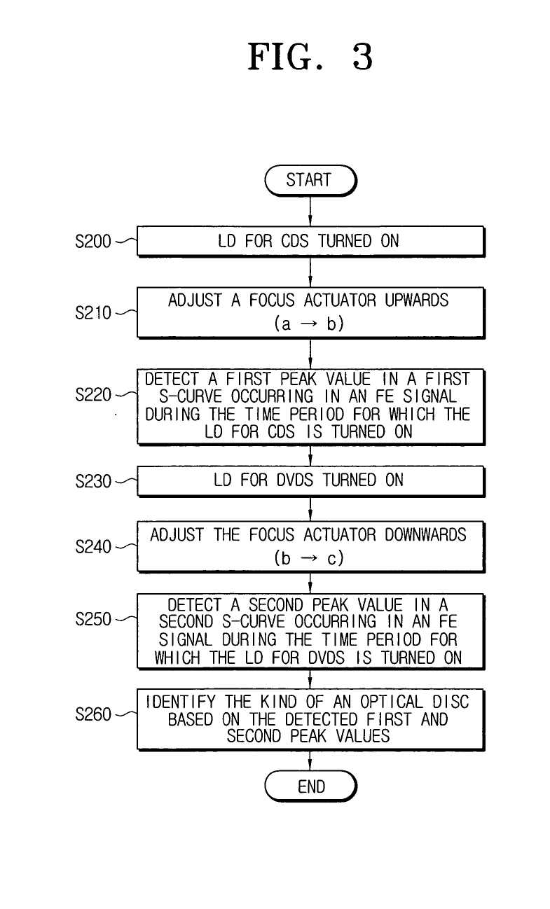

Descriptions of the waveforms of the FE signal are made with reference to FIGS. 2a through 2c when a CD, DVD-S, or DVD-D are respectively loaded.

First, when the normal CD is loaded, an FE signal appears as shown in FIG. 2, wherein the FE signal is detected during a rising period (a→b) of the FOD signal for moving the focus actuator 115 upwards, that is, during a time period when the laser diode 111 for CDs is turned on, and during a falling period (b→c) of the FOD signal for moving the focus actuator 115 downwards, that is, during a time period when the laser diode 112 for DVDs is turned on. Referring to FIG. 2a, it can be seen that a peak value of the first S-curve d detected during a time period when the laser diode 111 for CDs is turned on is larger than the peak value of the second S-curve e detected during a time period when the laser diode 112 for DVDs is turned on.

When a DVD-S is loaded, the FE signal appears as shown in FIG. 2b, which is detected during the time period when the laser diode 111 for CDs is turned on and during the time period when the laser diode 112 for DVDs is turned on. Thus, referring to FIG. 2B, it can be seen that a peak value of the second S-curve e detected during the time period when the laser diode 112 for DVDs is turned on is larger than the peak value of the first S-curve d detected during the time period when the laser diode 111 for CDs is turned on.

In the meantime, when a DVD-D is loaded, the FE signal appears as shown in FIG. 2c, which is detected during the time period when the laser diode 111 for CDs is turned on and during the time period when the laser diode 112 for DVDs is turned on. If a DVD-D is loaded, as shown in FIG. 2C, it can be seen that the peak value of the second S-curve e detected during the time period when the laser diode 112 for DVDs is turned on is larger than the peak value of the first S-curve d detected during the time period when the laser diode 111 for CDs is turned on and the second S-curve e occurs twice during the time period when the laser diode 112 for DVDs is turned on.

Hereinafter, a description is made of an exemplary optical disc identification method according to a preferred embodiment of the present invention with reference to FIGS. 1 through 4.

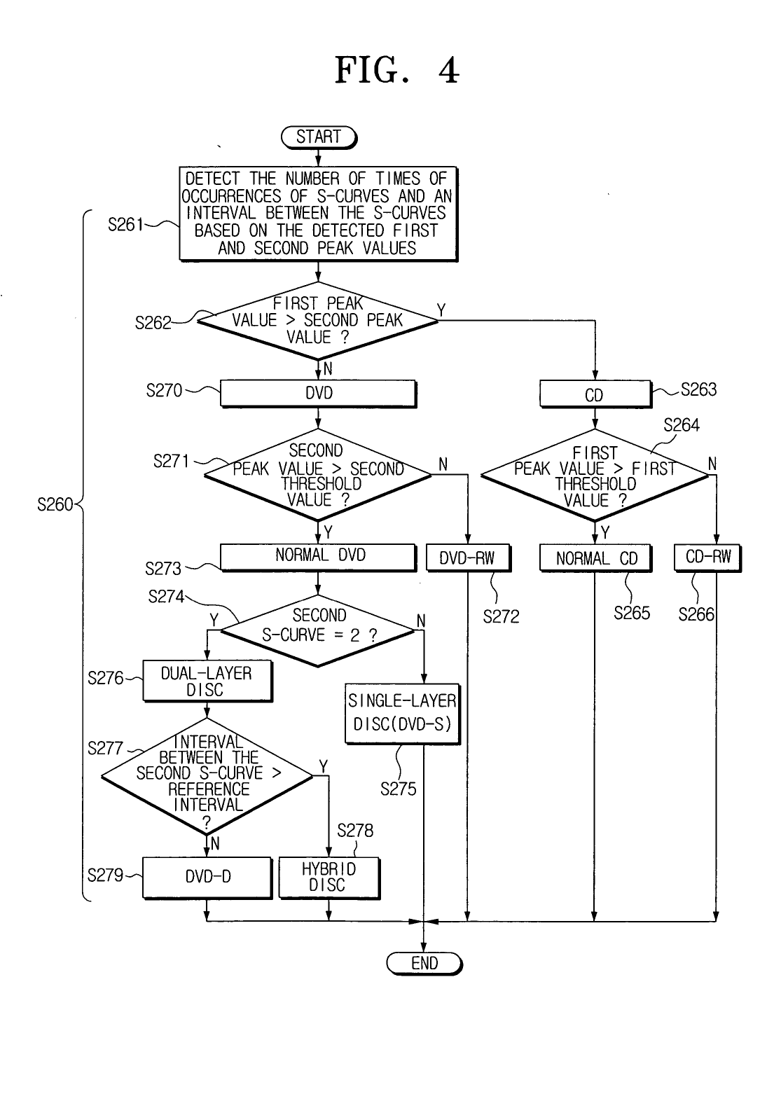

FIG. 3 and FIG. 4 are flow charts explaining an exemplary optical disc identification method for the optical disc identification apparatus shown in FIG. 1.

First, referring to FIGS. 1 through 3, the control unit 160 signals the APC unit 130 to turn on the laser diode 111 for CDs which is provided in the pickup unit 110 (S200). Further, the control unit 160 provides the focus actuator 115 with the FOD signal for moving the focus actuator 115 upwards from position a to position b (S210). If it is decided that the focus actuator 115 driven by the focus drive unit 150 has reached position b, the control unit 160 signals the APC unit 130 to turn off the laser diode 111 for CDs. Further, the control unit 160 controls the peak value detector 144 to detect a first peak value for the first S-curve d occurring in the FE signal detected through the photo detector 116 during the time period when the laser diode 111 for CDs is turned on (S220). The first peak value detected by the peak value detector 144 is supplied to the control unit 160. The control unit 160 signals the APC unit 130 to turn on the laser diode 112 for DVDs (S230). Further, the control unit 160 provides the focus actuator 115 with the FOD signal for moving the focus actuator 115 downwards to adjust the focus actuator 115 downwards from position b to position c (S240). If the focus actuator 115 has reached position c, the control unit 160 signals the APC unit 130 to turn off the laser diode 112 for DVDs. Further, the control unit 160 controls the peak value detector 144 to detect the second peak value as to the second S-curve e occurring in the FE signal detected through the photo detector 116 during the time period when the laser diode for DVDs is turned on (S250). The control unit 160 identifies the kind of optical disc 100a loaded in the optical disc drive based on the first and second peak values detected in the steps S220 and S250 (S260 ).

A more detailed description will be made of a method for the control unit 160 to identify the kinds of optical discs with reference to FIG. 4. The control unit 160 detects the number of occurrences of the first and second S-curves and the interval size between the respective S-curves based on the number and magnitude of the first and second peak values input from the peak value detector 144 (S261). The control unit 160 identifies the kind of loaded optical disc 100a based on number and magnitude of the first and second peak values, the number of occurrences of the respective detected S-curves, and the information on the interval size.

In more detail, the control unit 160 compares the first peak value and the second peak value in order to decide whether the loaded optical disc 100a belongs to the CD type or the DVD type (S262). If it is decided that the first peak value is larger than the second peak value and exceeds a first predetermined level as a result of the comparison, the control unit 160 decides that the loaded optical disc 100a belongs to the CD type (S263). If it is decided that the loaded optical disc 100a belongs to the CD type, the control unit 160 compares the first peak value with a first threshold value in order to decide whether the loaded CD is a normal CD or a CD-RW (S264). If it is decided that the first peak value is larger than the first threshold value in the step S264, the control unit 160 decides the loaded CD is a normal CD (S265). On the contrary, if it is decided that the first peak value is smaller than the first threshold value, the control unit 160 decides the loaded CD is a CD-RW (S266).

In step S262, if it is decided that the first peak value is less than the second peak value and within a second predetermined level, the control unit 160 decides that the loaded optical disc 100a belongs to the DVD type (S270). If it is decided that the loaded optical disc 100a belongs to the DVD type, the control unit 160 compares the second peak value with the second threshold value in order to decide whether the loaded DVD is a normal DVD or a DVD-RW (S271). If it is decided that the second peak value is smaller than the second threshold value as a result of the comparison, the control unit 160 decides the loaded DVD is a DVD-RW (S272). On the contrary, if it is decided that the second peak value is larger than the second threshold value, the control unit 160 decides the loaded DVD is a normal DVD (S273).

If it is decided that the loaded DVD is a normal DVD in step S273, the control unit 160 decides whether the DVD is a single-layer disc (DVD-S) or a dual-layer disc using the number of occurrences of the second S-curve. To do this, the control unit 160 decides whether the second S-curve occurs twice in the FE signal during the time period when the laser diode 112 for DVDs is turned on (S274). If it is decided that the second S-curve only occurs once in the FE signal during the time period when the laser diode 112 for DVDs is on, the control unit 160 decides the loaded DVD as a single-layer disc (DVD-S) (S275).

On the contrary, in step S274, if it is decided that the second S-curve occurs twice in the FE signal during the time period when the laser diode 112 for DVDs is on, the control unit 160 decides the loaded DVD as a dual-layer disc (S276). As described above, if the loaded DVD is decided to be a dual-layer disc, the control unit 160 decides whether the dual-layer disc is a DVD-D or a hybrid disc using the interval size between the second S-curves. To do this, the control unit 160 compares the interval between the detected second S-curve with a predetermined reference interval such as about 0.6 mm (S277). If the interval between the detected second S-curves is more than a reference interval as a result of the comparison, the control unit 160 decides the loaded DVD as a hybrid disc (S278). On the contrary, if it is decided that the interval between the detected second S-curves is less than the reference interval, the control unit 160 decides the loaded DVD as the DVD-D (S279).

As described thus far, an embodiment of the present invention identifies the kinds of loaded optical discs based on the peak value of the FE signal which is different depending upon the kind of optical discs loaded in the device. Thereby, increasing the accuracy of the identification of the loaded optical disc.

That is, the present invention can decide whether a loaded optical disc belongs to the CD type or the DVD type using the peak value magnitude of the FE signal detected when a light source for CDs is turned on and the peak value magnitude of the FE signal detected when a light source for DVDs is turned on. Thus, eliminating the measurement of the RF Sum signal to decide whether the loaded optical disc is the CD type or the DVD type as in the prior art. Accordingly, the present invention can reduce the load on the servo unit as well as reduce the time for identifying optical discs.

Further, the present invention can classify the kinds of optical discs using more information on the respective peak values, the number of occurrences of the detected S-curves, and the interval size between the S-curves.

Although the preferred embodiments of the present invention have been described, it will be understood by those skilled in the art that the present invention should not be limited to the described preferred embodiments, but various changes and modifications can be made within the spirit and scope of the present invention as defined by the appended claims.

1. An optical disc identification method in an optical disc drive, comprising steps of:
detecting a first peak value in a first S-curve occurring in a focus error signal detected through a photo detector when a light source for a first kind of optical disc is turned on;
a detecting a second peak value in a second S-curve occurring in a focus error signal detected through the photo detector when a light source for a second kind of optical disc is turned on; and
identifying the kind of a loaded optical disc in the optical disc drive based on the detected first and second peak values.

2. The optical disc identification method as claimed in claim 1, wherein the first S-curve is detected during the rising period of the focus actuator after the light source for the first kind of optical disc is turned on, and the second S-curve is detected during the falling period of the focus actuator after the light source for the second kind of optical disc is turned on.

3. The optical disc identification method as claimed in claim 1, further comprising a step of detecting the number of occurrences of the first and second S-curves and the intervals between the respective S curves based on the detected first and second peak values.

4. The optical disc identification method as claimed in claim 3, wherein the disc kind identification step further comprises a step of comparing the first peak value and the second peak value, and, if it is decided that the first peak value is larger than the second peak value and exceeds a first predetermined level as a result of the comparison, the loaded optical disc is decided to be the first kind of optical disc, and, if it is decided that the second peak value is less than the first peak value and within a second predetermined level, the loaded optical disc is decided to be the second kind of optical disc.

5. The optical disc identification method as claimed in claim 4, wherein the disc kind identification step compares the first and second peak values with predetermined first and second threshold values respectively, and decides whether the loaded optical disc is a normal disc or a rewritable disc.

6. The optical disc identification method as claimed in claim 4, wherein, if the loaded optical disc is decided to be the second kind of optical disc, the disc kind identification step decides whether the loaded optical disc is a single-layer disc or a dual-layer disc based on the number of occurrences of the first and second S-curves.

7. The optical disc identification method as claimed in claim 6, wherein, if the loaded optical disc is decided to be a dual-layer disc, the disc kind identification step decides whether the loaded optical disc is a normal disc or a hybrid disc based on whether the interval between the S-curves is more than a predetermined reference interval.

8. The optical disc identification method as claimed in claim 5, wherein the first kind of optical disc is a CD and the second kind of optical disc is a DVD.

9. An optical disc identification apparatus for an optical disc drive, comprising:
a pickup unit having light sources for first and second optical discs emitting different laser beams onto a loaded optical disc, a focus actuator for controlling a focus of the laser beams, and a photo detector for detecting the amount of laser light is reflected by the optical disc;
an RF signal processing unit for generating a focus error signal based on the amount of light detected by the photo detector during the rising and falling periods of the focus actuator;
a servo unit for detecting first and second peak values in first and second S-curves occurring in the focus error signal during the rising and falling periods of the focus actuator; and
a control unit for detecting the number of occurrences of the first and second S-curves and intervals between the first and second S-curves based on first and second peak values detected by the servo unit and identifying the kind of the loaded optical disc based on the first and second peak values and the detected information.

10. The optical disc identification apparatus as claimed in claim 9, wherein the control unit signals the light source for the first optical disc to be turn on during the rising period of the focus actuator, and signals the light source for the second optical disc to be turned on during the falling period of the focus actuator.

11. The optical disc identification apparatus as claimed in claim 10, wherein the control unit compares the first peak value and the second peak value, decides the loaded optical disc is the first optical disc if the first peak value is larger than the second peak value and exceeds a first predetermined level, and decides the loaded optical disc is the second optical disc if the second peak value is less than the first peak value and within a second predetermined level.

12. The optical disc identification apparatus as claimed in claim 11, wherein the control unit compares the first and second peak values with predetermined first and second threshold values respectively, and decides whether the loaded optical disc is a normal disc or a rewritable disc.

13. The optical disc identification apparatus as claimed in claim 11, wherein the control unit decides whether the loaded optical disc is a single-layer disc or a dual-layer disc based on the number of occurrences of the first and second S-curves if the loaded optical disc is decided to be the second optical disc.

14. The optical disc identification apparatus as claimed in claim 13, wherein the control unit decides whether the loaded optical disc is a normal disc or a hybrid disc based on whether the interval between the respective S-curves is more than a predetermined reference interval if the loaded optical disc is decided to be a dual-layer disc.

15. The optical disc identification apparatus as claimed in claim 11, wherein the first optical disc is a CD and the second optical disc is a DVD.
